(19) United States
(12) Patent Application Publication
(10) Pub. No.: US 2011/0097606 A1
(43) Pub. Date: Apr. 28, 2011

(54) BATTERY PACK WITH PRECISE DIMENSIONS

(76) Inventor: Takashi NAMURA, Sumoto-shi (JP)

(21) Appl. No.: 12/906,451

(22) Filed: Oct. 18, 2010

(30) Foreign Application Priority Data
Oct. 22, 2009 (JP) 2009-243478

(51) Int. Cl. H01M 2/00; H01M 2/04

(52) U.S. Cl. 429/7

(57) ABSTRACT

The battery pack has a battery cell 11, a circuit board 22 disposed along one end-plane 11a of the battery cell 11,and a circuit board holder 23 that intervenes between the circuit board 22 and the battery cell 11 end-plane 11a. The circuit board holder 23 is provided with a main body that holds the circuit board 22 and four projections 23h-23k protruding towards the end-plane 11a of the battery cell 11 (in the negative direction along the X-axis). Further, the projections 23h-23k on the circuit board holder 23 have lower mechanical strength than the main body and function as buffers to absorb dimension variation in the battery cell 11. Specifically, the end regions of the projections 23h-23k that contact an insulating board 12 disposed on top of the battery cell 11 end-plane 11a are squashed down by just an amount to absorb the battery cell 11 dimension variation.

### BACKGROUND OF THE INVENTION

1. Field of the Invention

The present invention relates to a battery pack, and in particular relates to a battery pack structure to improve the accuracy of battery pack dimensions upon completion of fabrication.

2. Description of the Related Art

A battery pack is used as a power source in mobile electronic devices such as cellular (mobile) telephones (Refer to Japanese Patent No. 3668195 and Japanese Laid-Open Patent Publication 2006-66290). FIG. 11 is used to describe an example of the structure of a prior art battery pack. As shown in FIG. 11, a prior art battery pack has a battery cell 911 with a flat solid rectangular external shape, and a PTC (positive temperature coefficient) device 913 and circuit board 922 disposed along a battery cell 911 end-plane 911a at the left-front along the X-axis of the figure. The PTC device 913 is connected via a lead-plate 914 to the negative electrode terminal 911b that protrudes out from the battery cell 911 end-plane 911a. An insulating board 912 intervenes between the battery cell 911 end-plane 911a and the PTC device 913 assembly to establish electrical insulation, and the lead-plate 914 connects to the negative electrode terminal 911b through a window 912a provided in the insulating board 912.

The circuit board 922 position is set relative to the battery cell 911 end-plane 911a with a circuit board holder 923 sandwiched in between. The circuit board 922 is provided with two circuit board leads 922d and 922e extending inward to the right along the X-axis of the figure. One of the circuit board leads 922d connects to the PTC device 913 via a lead-plate 915, and the other circuit board lead 922e connects to the battery cell 911 external case positive electrode terminal via a clad material plate 911c and a lead-plate 916.

The battery cell 911 end-plane 911a with the PTC device 913 and circuit board 922 attached is covered by a cap 921. The cap 921 is joined to the battery cell 911 external case, and is provided with three windows 921a-921c at the left-front along the X-axis of the figure. The purpose of these windows 921a-921c is to externally expose connecting terminals 922a-922c provided on a primary surface of the circuit board 922 also at the left-front along the X-axis.

A bottom cover 931 is attached via an insulating board 932 to the battery cell 911 end-plane at the right-rear along the X-axis of the figure, and battery cell 911 perimeter surfaces are covered by an outer label 930. Further, JP 3668195 B discloses insertion molding using low temperature resin of the battery cell 911 end-plane 911a structure covered with the PTC device 913 and circuit board 922.

However, in the prior art battery pack described above, the X-axis dimension is set by the length L₃ of the battery cell 911, and variation in the length L₃ of the battery cell 911 results in variation in the length dimension of . the battery pack. When demands for battery pack attachment reliability and further miniaturization of devices that the battery pack attaches to are considered, these types of prior art battery pack dimension variations become a major problem. The object of the present invention is to suppress the effects of variation in battery cell dimensions and provide a battery pack with highly precise dimensions.

### SUMMARY OF THE INVENTION

To achieve the object described above, the present invention employs the following structure. The battery pack of the present invention has a battery cell, a circuit board disposed along one end-plane of the battery cell, and a circuit board holder that intervenes between the circuit board and the battery cell end-plane. The circuit board holder is provided with a main body and one or a plurality of projections protruding towards the end-plane of the battery cell. Further, the battery pack of the present invention is characterized in that the projections on the circuit board holder have lower mechanical strength than the main body and act as buffer extensions to absorb dimension variation in the battery cell.

In addition, the battery pack of the present invention has a battery cell, a circuit board disposed along one end-plane of the battery cell, and a cap that covers the circuit board and the battery cell end-plane. The side of the cap that faces the battery cell (end-plane) is provided with one or a plurality of projections protruding towards the end-plane of the battery cell. Here, the battery pack of the present invention is characterized in that the projections on the cap have lower mechanical strength than the rest of the cap and act as buffer extensions to absorb dimension variation in the battery cell.

Further, the battery pack of the present invention has a battery cell, a circuit board disposed along one end-plane of the battery cell, and a cap that covers the circuit board and the battery cell end-plane. A lead-plate is joined to the end-plane of the battery cell, and that lead-plate has a surface that stands up from the end-plane and extends in the direction of the circuit board. The circuit board also has a lead-plate with a surface that stands up from the circuit board and extends toward the battery cell end-plane. The circuit board lead-plate connects to the lead-plate on the battery cell end-plane at an overlapping region. This battery pack configuration is characterized by provision of holes on both sides of the cap at positions corresponding to the overlapping region of the battery cell lead-plate and the circuit board lead-plate, and those holes are opened in directions perpendicular to the primary surfaces of both lead-plates.

The battery pack of the present invention as described above has projections on the circuit board holder with mechanical strength lower than the main body. Consequently, during battery pack assembly, when the circuit board holder is pressed against the end-plane of the battery cell (or against an insulating board on top of the end-plane) the projections deform and become squashed. Specifically, the projections on the circuit board holder are structural elements that function as buffers to absorb dimension variation in the battery cell. Accordingly, even when battery cell dimensions vary, the finished product compensates for the dimension variation by the function of the projections described above. For example, when battery cell dimensions are at the design limit, precise battery pack dimensions are maintained by squashing at least part of the circuit board holder projections as described above.

Therefore, the battery pack of the present invention can suppress the effects of battery cell dimension variation to achieve highly precise dimensions. Further, as previously described, a circuit board holder is not always a necessary structural element of the battery pack of the present invention. It is also possible for projections provided on a cap to function as the buffer extensions to absorb battery cell dimension variation. When this type of structure is adopted as well, the same effects described above are obtained.

The configuration described below can be adopted as one example of the battery pack of the present invention described above. When viewed perpendicular to the battery cell end-plane, the circuit board holder can have a long rectangular shape, and the projections on the circuit board holder can be provided at the four corners of that rectangular circuit board holder. In this case, when the projections are provided at the four corners, the structure has superior properties from the standpoint of stability.

Further, the battery pack of the present invention can have a configuration where the ends of the projections on the circuit board holder contact the battery cell end-plane or an insulating board disposed on top of the end-plane, and the contacting segments of the projections can become squashed. As described previously, even when battery cell dimensions are at the design limit, this configuration can achieve precise dimensions for the overall battery pack by squashing the circuit board holder projections.

In addition, the battery pack of the present invention can have a circuit board holder formed from resin material employing a single-piece structure for the main body and the projections. In this type of structure, the number of parts can be reduced, and complex operations during fabrication can be avoided to allow manufacturing cost reduction. Further, the battery pack of the present invention has a lead-plate joined to the end-plane of the battery cell, and that lead-plate has a surface that stands up from the end-plane and extends in the direction of the circuit board. The circuit board also has a lead-plate with a surface that stands up from the circuit board and extends toward the battery cell end-plane. The circuit board lead-plate connects to the lead-plate on the battery cell end-plane at an overlapping region. In this battery pack, the battery cell end-plane, the circuit board, and the circuit board holder are covered by a cap. Holes are provided on both sides of the cap at positions corresponding to the overlapping region of the battery cell lead-plate and the circuit board lead-plate, and those holes are opened in directions perpendicular to the primary surfaces of both lead-plates. Here, the cap is a separate assembly part and is not formed by insertion molding.

In this type of structure, the circuit board and circuit board holder can be assembled in the cap as a module (cap unit), and parts including lead-plates can be assembled on the battery cell as a module (battery cell unit). When these prepared-in-advance units are joined together, welding electrodes can be inserted through the holes opened through the cap to weld-attach the lead-plates. Consequently, since the cap unit and the battery cell unit are prepared ahead of time, it is possible to reduce the time for the manufacturing flow, which ultimately allows the manufacturing cost to be reduced. In this type of structure, the holes in the cap can be covered with sheet material at the end of production to prevent moisture and dirt from entering inside the cap. This allows a high degree of safety to be attained.

In the configuration described above, the cap unit and battery cell unit are prepared ahead of time and the lead-plates are connected at overlapping regions by inserting welding electrodes through the holes in the cap. This configuration is also applicable to a battery pack that is not provided with a circuit board holder. Further, even when a circuit board holder is provided, the results described above can be obtained without forming projections on the circuit board holder.

As described above, the battery pack of the present invention has a cap that is a separate part, which is not formed by insertion molding as in the battery pack cited in JP 3668195 B. Consequently, it is superior from the standpoint of manufacturing equipment cost. Specifically, when the cap section is formed by insertion molding, molds must be prepared corresponding to the shape of the cap section of each battery pack. When taking into account the manufacture of many different battery pack models, many molds must be stocked. Here, maintenance, control, and exchange of the molds become a factor that raises manufacturing cost.

In contrast, since the battery pack of the present invention has a cap that is a separate part, it is superior from a manufacturing cost perspective to the prior art battery pack that forms the cap section by insertion molding.

The above and further objects of the present invention as well as the features thereof will become more apparent from the following detailed description to be made in conjunction with the accompanying drawings.

### BRIEF DESCRIPTION OF THE DRAWINGS

FIG. 1 is a representative oblique view showing the external appearance of a battery pack 1 for the first embodiment;

FIG. 2 is an exploded oblique view showing the internal structure of the battery pack 1;

FIG. 3 are representative oblique views showing the structure of the circuit board holder 23 that is a component included in the battery pack 1;

FIG. 4 (a) is a exploded oblique view showing the structure of the cap unit 20 during the battery pack 1 manufacturing process, (b) is a exploded oblique view showing the structure of the battery cell unit 10 during the battery pack 1 manufacturing process;

FIG. 5 is a representative oblique view showing the assembly step to attach the cap unit 20 to the battery cell unit 10 during the battery pack 1 manufacturing process;

FIG. 6 is a representative oblique view showing the circuit board holder 23 ribs 23f, 23h, 23i prior to being compressed in the assembly step to attach the cap unit 20 to the battery cell unit 10;

FIG. 7 is a representative oblique view showing the circuit board holder 23 ribs 23f, 23h, 23i after being compressed in the assembly step to attach the cap unit 20 to the battery cell unit 10;

FIG. 8 is a representative oblique view showing the step to form a junction between a lead-plate 16 and a circuit board lead 22e in the assembly step to attach the cap unit 20 to the battery cell unit 10;

FIG. 9 is a exploded oblique view showing the structure of the cap unit 40 provided on a battery pack 2 for the second embodiment;

FIG. 10 is a partially exploded oblique view showing primary structural elements of the battery pack 2 for the second embodiment; and

FIG. 11 is a representative oblique view showing the structure of a prior art battery pack.

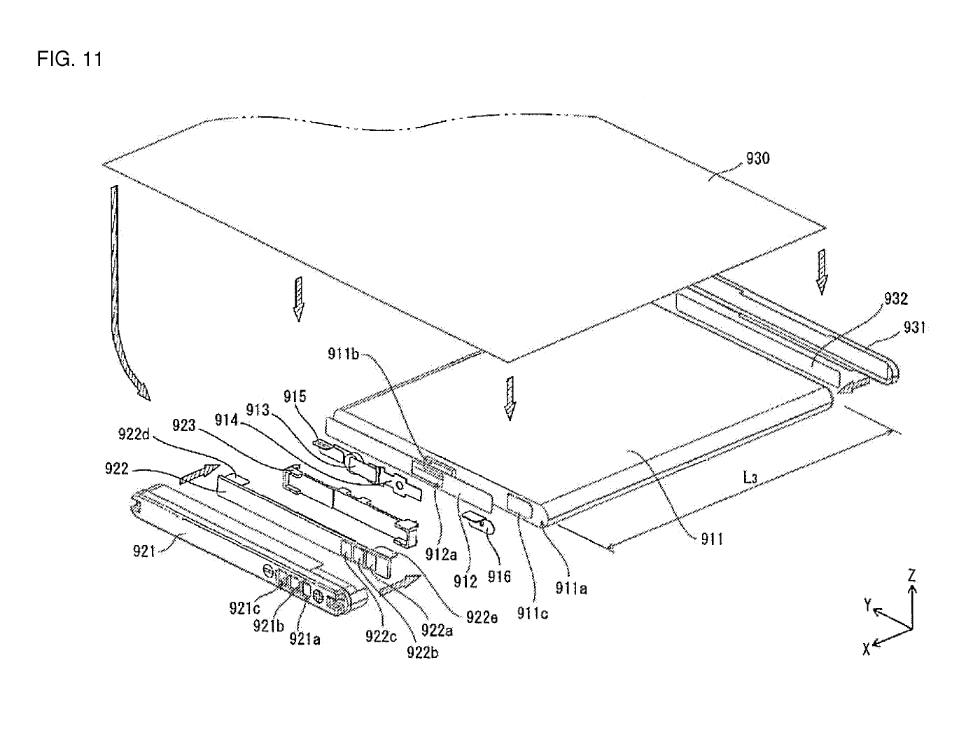

### DETAILED DESCRIPTION OF THE EMBODIMENTS

The following describes embodiments of the present invention based on the figures. However, embodiments 1 and 2 in the following description are used as examples to easily understand the structure, operation, and results of the present invention, and other than essential elements, the present invention is in no way limited to those embodiments.

### First Embodiment

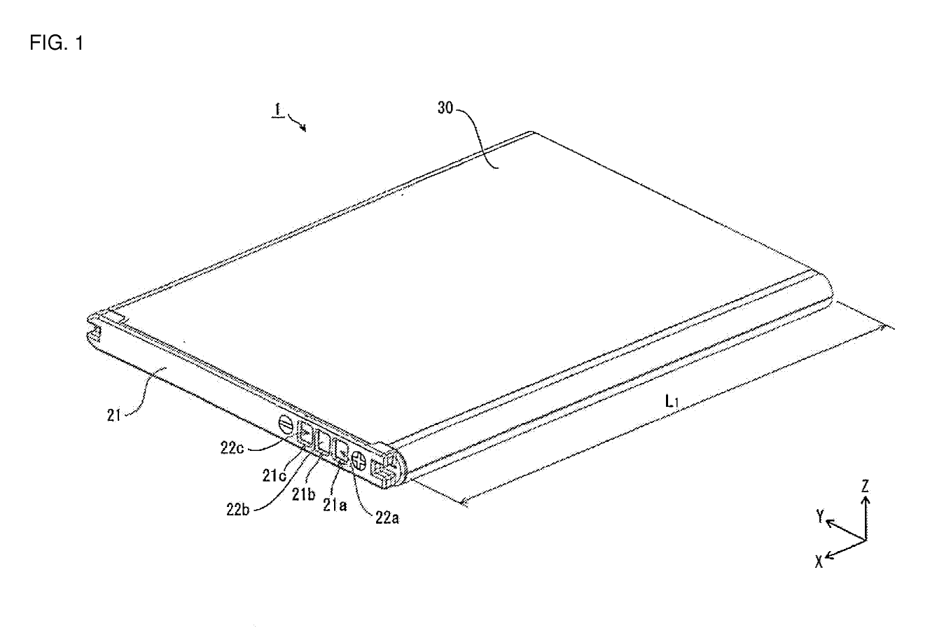

1.Battery pack 1 external structure
As shown in FIG. 1, the battery pack 1 for the first embodiment of the present invention has an external structure that includes a cap 21 disposed at the left-front on the X-axis, a bottom cover (not illustrated in FIG. 1) disposed at the right-rear on the X-axis, and an outer label 30 that covers the perimeter surfaces.

The cap 21 is provided with three windows 21a-21c, and external connecting terminals 22a-22c are exposed to the outside through those windows 21a-21c. The outer label 30 also covers part of the perimeter surfaces of the cap 21 and the bottom cover.

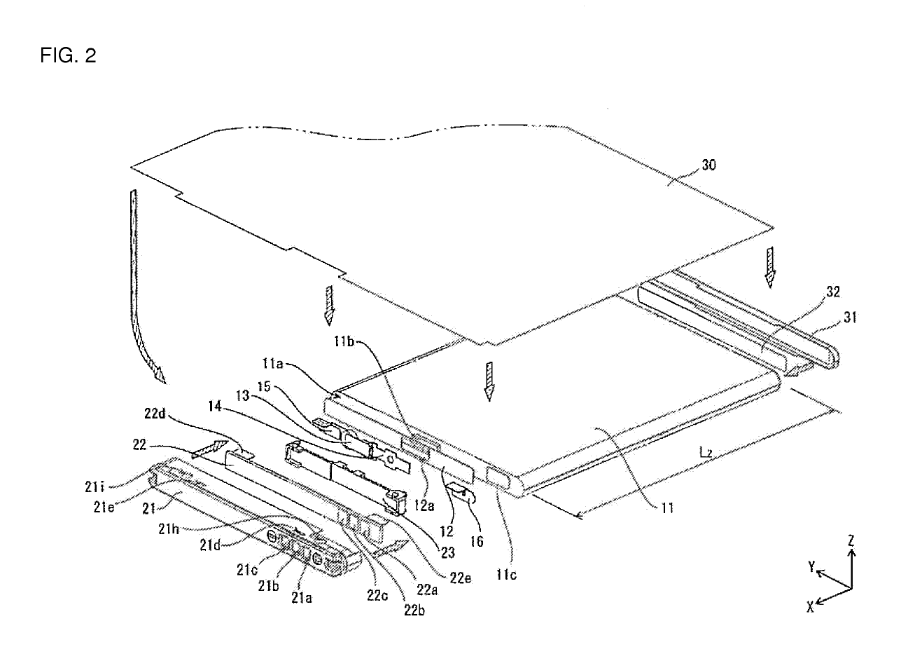

2.Battery pack 1 internal structure
As shown in FIG. 2, the battery pack 1 for the first embodiment of the present invention has a battery cell 11 with a flat solid rectangular external shape, and a positive temperature coefficient (PTC) device 13 and circuit board 22 disposed along the battery cell 11 end-plane 11 a at the left-front on the X-axis.

A lead-plate 14 and another lead-plate 15 are connected to the PTC device 13. One lead-plate 14 is connected to the negative electrode terminal 11b protruding from the end-plane 11a of the battery cell 11. Here, an insulating board 12 intervenes between the battery cell 11 end-plane 11a and the PTC device 13 with lead-plates 14, 15 to electrically insulate those components. Connection of the lead-plate 14 to the negative electrode terminal 11b is obtained through a window 12a opened through the insulating board 12.

A clad material plate 11c is joined to the battery cell 11 end-plane 11a at the right-end region of the Y-axis on the surface of the external case. A lead-plate 16 is connected to the clad material plate 11c. The purpose of the lead-plate 16 is to provide connection to the positive electrode terminal of the battery cell 11. The circuit board 22 is disposed in a specified position with respect to the end-plane 11a of the battery cell 11 with a circuit board holder 23 sandwiched between the circuit board 22 and the end-plane 11a. The circuit board 22 is provided with two circuit board lead-plates 22d, 22e extending inward to the right on the X-axis. One of the circuit board lead-plates 22d connects with the lead-plate 15 on the PTC device 13. The other circuit board lead-plate 22e connects to the lead-plate 16 on the clad material plate 11c. With these connections, the circuit board 22 is connected through the PTC device 13 and lead-plates 14, 15 to the battery cell 11 negative electrode terminal 11b, and through the lead-plate 16 and clad material plate 11c to the positive electrode terminal of the battery cell 11 external case.

The end-plane 11a of the battery cell 11 with the PTC device 13 and circuit board 22 attached is covered by the cap 21. The side-wall (skirt) regions of the cap 21 cover part of the external case of the battery cell 11, and part of the perimeter surfaces of the cap 21 are covered by the outer label 30. The cap 21 is made from insulating material (for example, polyamide-system resin material). The three windows 21a-21c are provided in the cap 21 at the left-front on the X-axis, and the external connecting terminals 22a-22c formed on a primary surface of the circuit board 22 (at the left-front on the X-axis) are configured for exposure through those windows 21a-21c. Here, the external connecting terminals 22a-22c on the circuit board 22 are established in a form such as a metal (for example, Au, Cu, and Ni) thin-film on a primary surface of the circuit board 22.

The side surfaces of the cap 21 are provided with rectangular holes 21d, 21e and adjacently disposed round holes 21h, 21i opened for purposes described later. The bottom cover 31 is attached with an intervening insulating board 32 to the battery cell 11 end-plane at the right-rear on the X-axis, and part of the perimeter surfaces are covered by the outer label 30 in the same manner as the cap 21.

In the battery pack 1 for present embodiment, a lithium ion rechargeable battery is used, for example, as the battery cell 11. Further, although not illustrated, electronic components implementing protection circuitry are mounted on the circuit board 22.

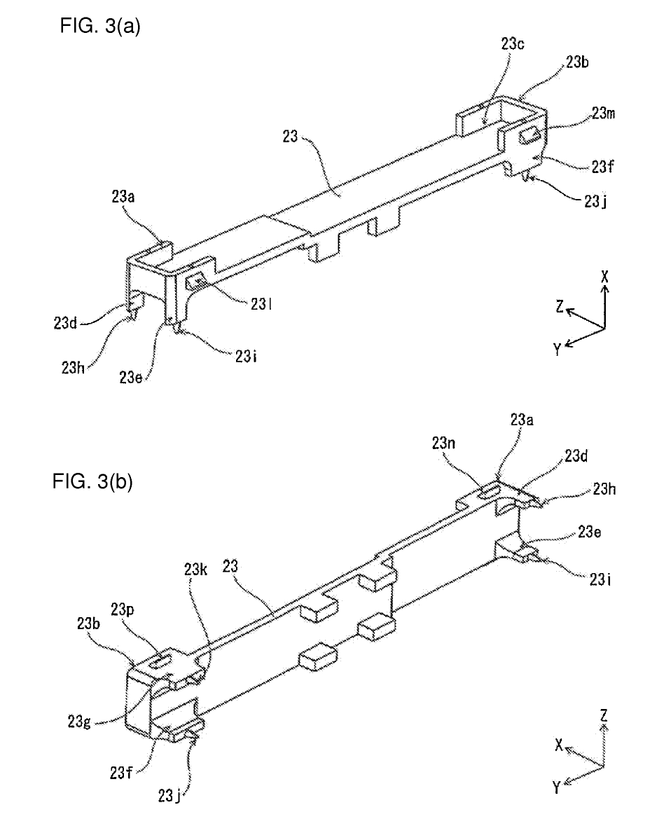

3. Circuit board holder 23 structure
As shown in FIG. 3(a), when viewed from above along the X-axis, the circuit board holder 23 has a long rectangular shape that conforms to the outline of the circuit board 22. Frame pieces 23a, 23b are formed extending upright in the X-axis direction on the top side of the circuit board holder 23, and the frame pieces 23a, 23b form a retaining section 23c to hold the circuit board 22.

As shown in FIG. 3(b), four legs 23d-23g are formed extending along the X-axis from the four corners on the backside of the retaining section 23c. In addition, very small conical projections 23h-23k are provided protruding from the legs 23d-23g. The projections 23h-23k have an extremely small cross-section through a plane perpendicular to the X-axis compared to the legs 23d-23g and the retaining section 23c, which is the main body of the circuit board holder 23. Accordingly the mechanical strength of the projections 23h-23k is low. However, the projections 23h-23k have a degree of mechanical strength that can avoid deformation due to external impact forces occurring during use of the finished battery pack 1.

As shown in FIG. 3(a) and FIG. 3(b), the circuit board holder 23 has four locking pieces 23l, 23m, 23n, 23p formed on its side surface regions. These locking pieces 23l, 23m, 23n, 23p are provided to lock into the rectangular holes 21d, 21e, 21f, 21g in the cap 21.

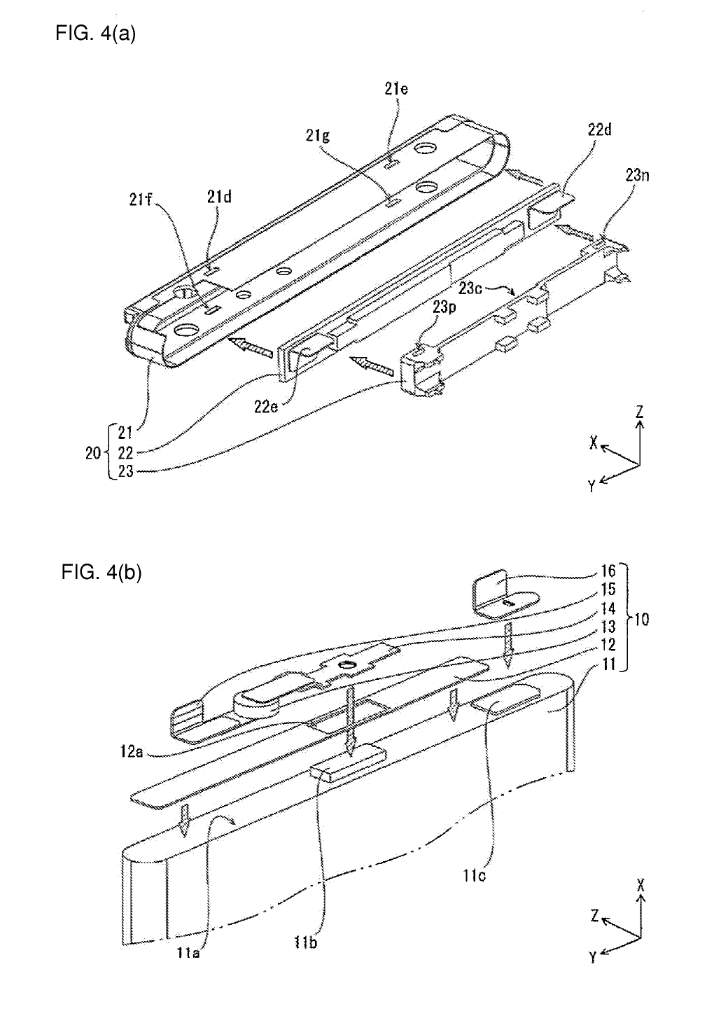

4. Battery pack 1 manufacture
(1) Formation of the cap unit
As shown in FIG. 4(a), the circuit board 22 and the circuit board holder 23 are inserted inside the cap 21. As described previously, the four locking pieces 23l, 23m, 23n, 23p on the circuit board holder 23 (only locking pieces 23n, 23p are shown in FIG. 4[a]) lock into the rectangular holes 21d-21g provided in the cap 21. By inserting the locking pieces 23l, 23m, 23n, 23p into the rectangular holes 21d-21g, the circuit board 22 is pressed against the inside surface of the cap 21 by the circuit board holder 23.

Here, the circuit board lead-plates 22d, 22e are disposed on the circuit board 22 on the Y-axis outside the locations of the locking pieces 23l, 23m, 23n, 23p and the mating rectangular holes 21d-21g. Therefore, the circuit board lead-plates 22d, 22e do not interfere with insertion of the locking pieces 23l, 23m, 23n, 23p. This completes formation of the cap unit 20.

(2) Formation of the battery cell unit
As shown in FIG. 4(b), the insulating board 12 is disposed on the end-plane 11a at the top of the battery cell 11 in the X-axis direction. As described previously, the insulating board 12 is provided with a window 12a opened at a location corresponding to the negative electrode terminal 11b of the battery cell 11. The lead-plate 14 is joined to the negative electrode terminal 11b through the window 12a. The lead-plate 14 and the other lead-plate 15 are joined in advance to the PTC device 13.

In addition, the clad material plate 11c is joined to the battery cell 11 end-plane 11a, and the lead-plate 16 is joined to the clad material plate 11c. This completes formation of the battery cell unit 10.

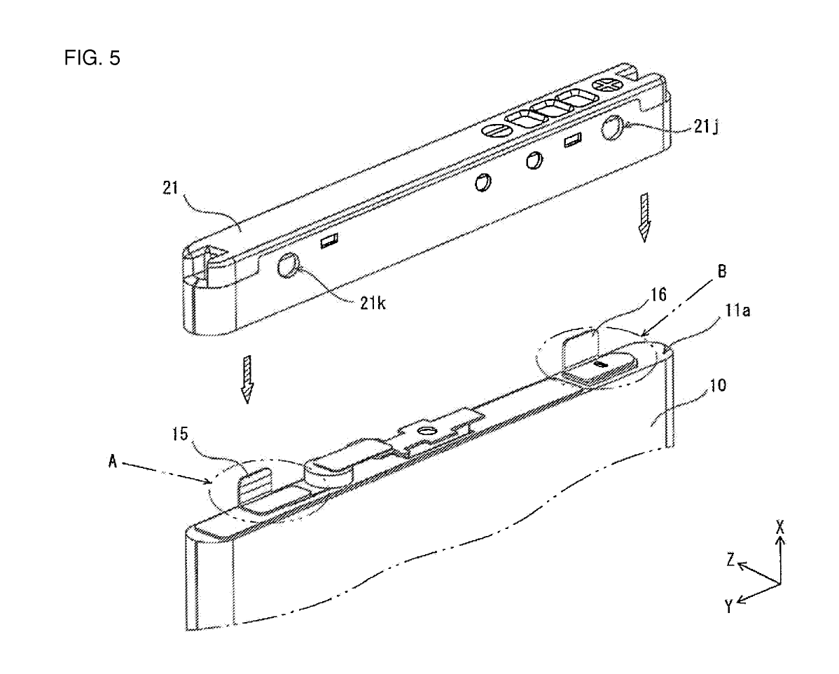

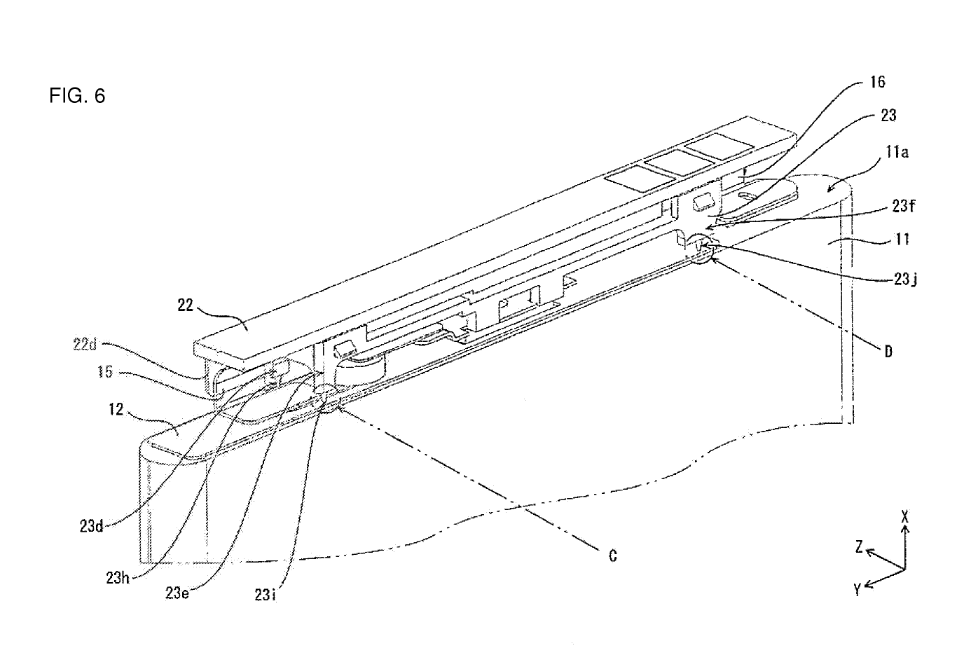

(3) Attachment of the cap unit 20 to the battery cell unit 10
As shown in FIG. 5, the cap unit 20 is attached to the battery cell unit 10 in a manner that covers the battery cell 11 end-plane 11a. At this time, the circuit board lead-plates 22d, 22e (refer to FIG. 2, FIG. 4[a], and FIG. 4[b]) in the cap unit 20 and the lead-plates 15, 16 on the battery cell unit 10 overlap (arrows A and B in FIG. 5) inside the cap unit 20. Further, the holes 21h-21k (refer to FIG. 2) are opened through the cap 21 at locations corresponding to the overlapping regions of the circuit board lead-plates 22d, 22e and the lead-plates 15, 16.
(4) Dimension adjustment during cap unit 20 to battery cell unit 10 attachment
As shown in FIG. 6, when the cap unit 20 is mounted on the battery cell unit 10, initially the end of each projection 23h, 23i, 23j, 23k on the circuit board holder 23 makes contact with the battery cell unit 10 insulating board 12 or the battery cell 11 end-plane 11a (arrows C and D in FIG. 6). In this configuration, the total length of the battery cell 11, which is L₂ (refer to FIG. 2), plus the length of the cap unit 20 is longer than the design length L₁ (refer to FIG. 1) of the battery pack 1.

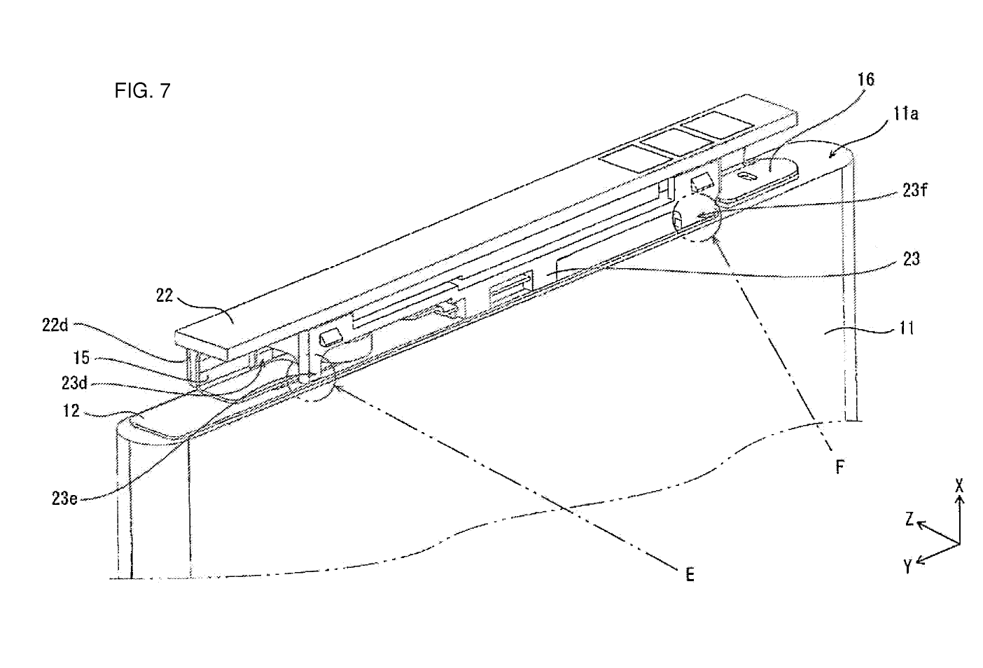

Next, the cap unit 20 is attached to the battery cell unit 10 by inserting the assembly shown in FIG. 6 into a special-purpose set-up tool made to the design length of the battery pack 1. As shown in FIG. 7, depending on the variation in battery cell 11 length L₂ (refer to FIG. 2), the circuit board holder 23 projections 23h, 23i, 23j, 23k are squashed down from their ends (arrows E and F in FIG. 7) due to compression force applied in the X-axis direction.

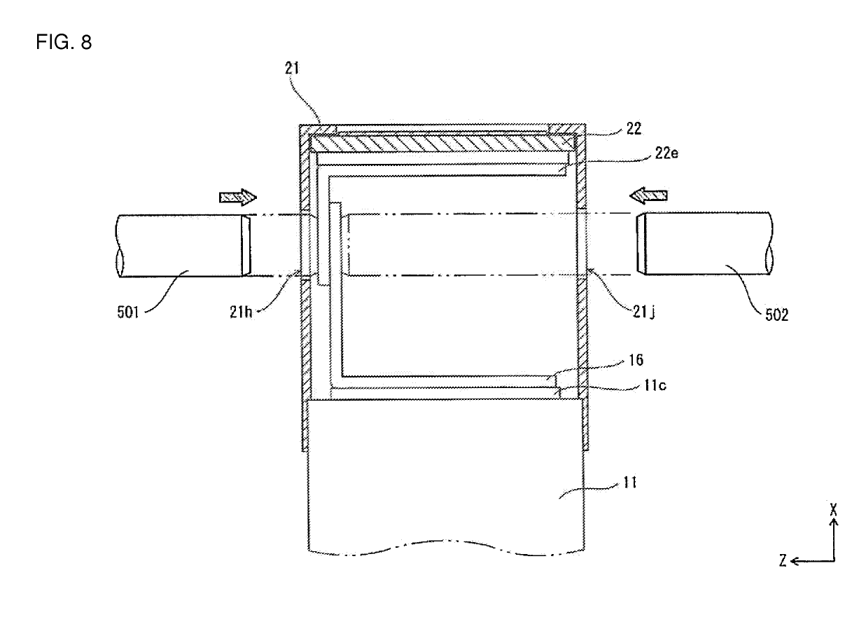

Lastly, as shown in FIG. 8, welding electrodes 501, 502 are inserted into the holes 21h-21k opened through the cap 21 (only holes 21h, 21j are shown in FIG. 8) to weld-attach the circuit board lead-plates 22d, 22e (only circuit board lead-plate 22e is shown in FIG. 8) to the lead-plates 15, 16 (only lead-plate 16 is shown in FIG. 8). Here, the sizes of the holes 21h-21k in the cap 21 are set considering the cross-section size of the welding electrodes 501, 502 used.

In FIGS. 6 and 7, the cap 21 was not illustrated for convenience. However, as shown in FIG. 5, when the cap unit 20 is mounted on the battery cell unit 10, the circuit board 22 and circuit board holder 23 are assembled in the cap 21 as a cap unit 20. This completes attachment of the cap unit 20 to the battery cell unit 10.

5.Outstanding properties
As shown in FIG. 3(b), the battery pack 1 of the first embodiment is provided with four projections 23h-23k on the circuit board holder 23 that have a mechanical strength which is lower than that of the main body (retaining section 23c and legs 23d-23g). As shown in FIG. 7, the circuit board holder 23 projections 23h-23k are squashed according to the battery cell 11 length L₂ and function as buffers that absorb variation in battery cell 11 length L₂.

As a result of the above described role of the four projections 23h-23k on the circuit board holder 23, the length of the finished product L₁, (refer to FIG. 1) is assured even when there is variation in the length L₂ of the battery cell 11. Consequently, the effect of battery cell 11 length L₂ variation on the battery pack 1 can be suppressed, and proper battery pack 1 length L₁ can be achieved with high precision.

Since the projections 23h-23k are established at the four corners of the circuit board holder 23, the system has exceptional properties from the standpoint of stability when the cap unit 20 is mounted on the battery cell unit 10. Further, the circuit board holder 23 can be molded from resin material and the main body (retaining section 23c and legs 23d-23g) and the projections 23h-23k can be formed as a single-piece structure. Therefore, the number of parts can be reduced, complex operations can be avoided during manufacture, and manufacturing cost can be reduced. In addition, since the projections 23h-23k are resin material, the external case of the battery cell 11 does not incur damage.

During battery pack 1 manufacture, welding electrodes 501, 502 are inserted into the holes 21h-21k provided in the cap 21 to join the circuit board lead-plates 22d, 22e to the lead-plates 15, 16 (refer to FIG. 8). As shown in FIGS. 4(a) and 4(b), the battery cell unit 10 and cap unit 20 are prepared in advance for manufacture of a battery pack 1 with this configuration. Accordingly, manufacturing operation efficiency can be increased as a result of battery cell unit 10 and the cap unit 20 assembly. Consequently, compared to the manufacture of prior art battery packs, manufacturing flow time can be reduced and this ultimately allows manufacturing cost to be reduced.

As described above for the present embodiment, projections 23h-23k are provided on the circuit board holder 23, and those projections 23h-23k function as buffers to suppress the effects of dimension variation in the battery cell 11. However, even when projections are not provided on the circuit board holder, it is possible to suppress the effects of battery cell 11 dimension variation and manufacture a battery pack having highly precise dimensions. For example, even if projections are not provided on the circuit board holder 23, when the cap unit 20 is mounted on the battery cell unit 10 (as shown in FIG. 5) prior to weld-attachment of the circuit board lead-plates 22d, 22e to the lead-plates 15, 16 (as shown in FIG. 8), the relative position of the cap unit 20 and the battery cell unit 10 can be adjusted in the X-axis direction. Even when this system is employed, dimension variation can be reduced, and battery pack structure and method of manufacture can be simplified.

Further, the battery pack 1 has a cap 21 that is a separate part not formed by insertion molding as in the battery pack cited in JP 3668195 B. Consequently, there is no need to prepare molds corresponding to the shape of the cap region of each different model, and manufacturing cost can be reduced from the standpoint of maintenance, control, and exchange of the molds.

### Second Embodiment

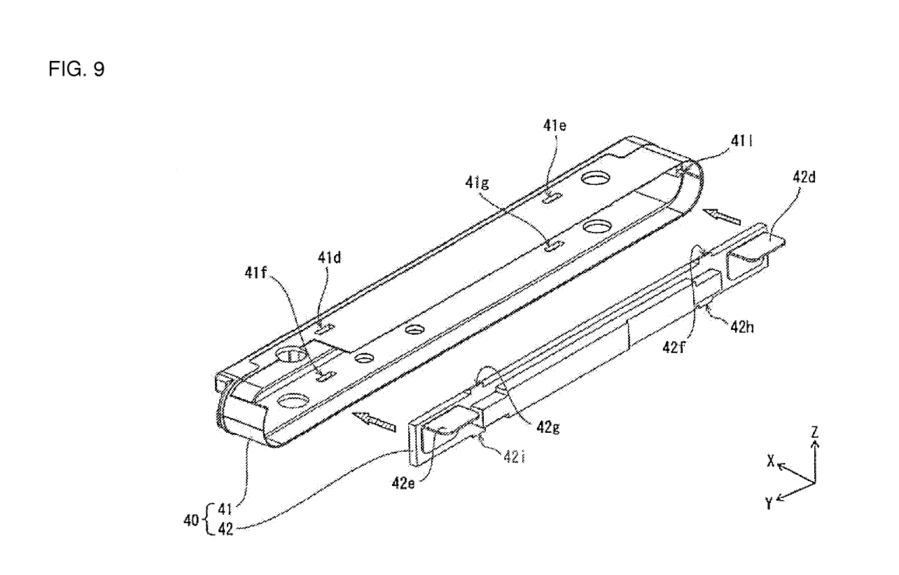

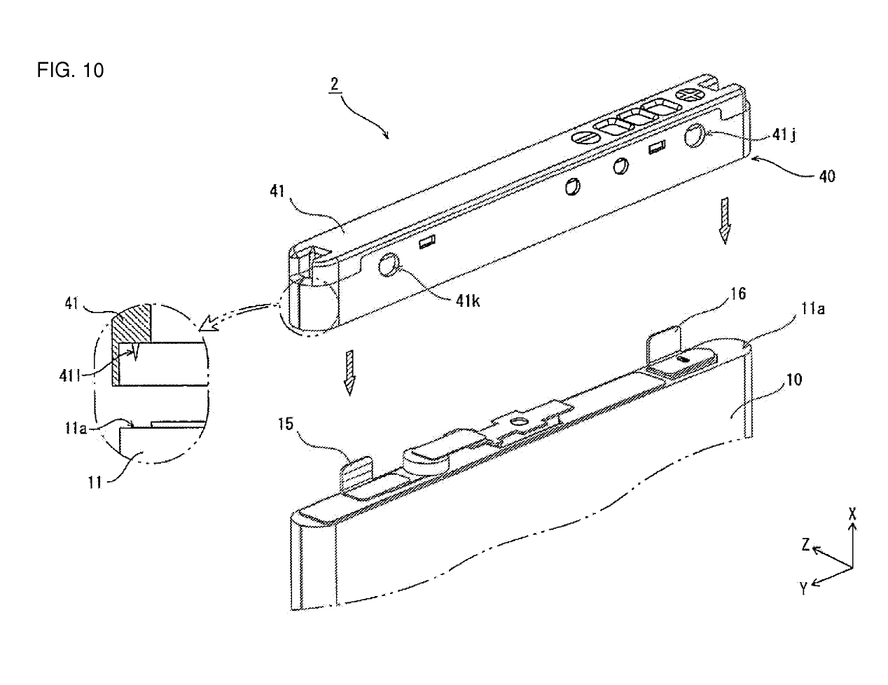

FIGS. 9 and 10 are used to describe the structure of the battery pack 2 for the second embodiment of the present invention. Here, description of structures common to the battery pack 1 for the previously described first embodiment is abbreviated, and emphasis is placed on the description of elements that are different.
1. Cap unit 40 structure
As shown in FIG. 9, the cap unit 40 for the second embodiment is configured as an assembly of a cap 41 and a circuit board 42 with the circuit board holder eliminated. Specifically, the cap 41 is provided with rectangular holes 41d, 41e, 41f, 41g through the side-wall surfaces. Further, the cap 41 has two projections 41l . . . (only one projection 41l is shown in FIG. 9) on the inside of the cap 41 at both ends along the Y-axis that extend towards the right-front along the X-axis.

The circuit board 42 is provided with two circuit board lead-plates 42d, 42e on a primary surface at the right-front along the X-axis. Further, locking pieces 42f, 42g, 42h, 42i are established projecting from upward and downward along the Z-axis at four locations on the edges of the circuit board 42. The circuit board 42 is inserted inside the cap 41 and the locking pieces 42f, 42g, 42h, 42i provided on the circuit board 42 insert into the holes 41d, 41e, 41f, 41g opened through the cap 41 to retain the circuit board 42 in the cap 41.

Although not illustrated in FIG. 9, the cap 41 is provided with windows to expose external connecting terminals provided on a primary surface of the circuit board 42 to the left-rear along the X-axis. This part of the structure is common to the previously described first embodiment.

2. Dimension adjustment during cap unit 40 to battery cell unit 10 attachment
As shown in FIG. 10, when the cap unit 40 is mounted on the battery cell unit 10, initially the ends of the two projections 41l . . . (refer to the enlarged inset in FIG. 10) provided on the cap 41 make contact with battery cell 11 end-plane 11a (sealing plate) of the battery cell unit 10. Next, the assembly is inserted in a special-purpose set-up tool (not illustrated) made to the design length of the battery pack 2 in the same manner described for the first embodiment. As a result, depending on the variation in battery cell 11 length, the projections 41l . . . provided on the cap 41 are squashed down from their ends due to compression force applied in the X-axis direction (refer to the enlarged inset in FIG. 10) in a manner similar to the first embodiment.

Lastly, in the same manner shown in FIG. 8, welding electrodes are inserted into the holes 41j, 41k . . . opened through the cap 41 to weld-attach the circuit board lead-plates 42d, 42e (refer to FIG. 9) to the lead-plates 15, 16. Note that the projections 41l . . . on the cap 41 are not always necessarily squashed down. For example, in the case where the battery cell 11 dimension is smaller than the design value, the projections 41l . . . may not squashed and can remain in their original state even after completion of battery pack 2 fabrication.

This completes attachment of the cap unit 40 to the battery cell unit 10. However, in the manufacture of the battery pack 2, the bottom cover and the outer label are subsequently attached. These operations are the same for the previously described first embodiment as well.

3. Outstanding properties
In the battery pack 2 for the second embodiment of the present invention, the projections 41l . . . provided on the cap 41 are squashed down according to the battery cell 11 length, and function as buffers that absorb variation in battery cell 11 length. As a result of this function of the two projections 41l . . . on the cap 41 of the battery pack 2 for the second embodiment, the length of the finished product (refer to FIG. 1) is assured even when there is variation in the length of the battery cell 11.

Further, during battery pack 2 manufacture, welding electrodes are inserted into the holes 41j, 41k . . . provided in the cap 41 to join the circuit board lead-plates 42d, 42e to the lead-plates 15, 16. Compared to prior art battery pack manufacture, manufacturing flow time can be reduced in the same manner as for the first embodiment, and this ultimately allows manufacturing cost to be reduced

In this second embodiment as well, projections 41l . . . are provided on the cap 41, and those projections 41l . . . function as buffers to suppress the effects of dimension variation in the battery cell 11. However, even when projections are not provided on the cap 41, it is possible to suppress the effects of battery cell 11 dimension variation and manufacture a battery pack having highly precise dimensions. For example, even when projections are not provided on the cap 41, when the cap unit 40 is mounted on the battery cell unit 10 (as shown in FIG. 10) prior to weld-attachment of the circuit board lead-plates 42d, 42e to the lead-plates 15, 16, the relative position of the cap unit 40 and the battery cell unit 10 can be adjusted in the X-axis direction of FIG. 10. Even when this system is employed, dimension variation can be reduced, and battery pack structure and method of manufacture can be simplified.

Finally, since the battery pack 2 of the second embodiment adopts a configuration that directly retains the circuit board 42 in the cap 41, further manufacturing cost reduction is possible compared to the first embodiment by an amount equivalent to the elimination of the circuit board holder 23.

### Other Considerations

Although the previously described first and second embodiments showed battery pack 1, 2 examples provided with a flat solid rectangular battery cell 11, battery cell shape and the number of battery cells are in no way limited to that configuration. For example, a configuration provided with two or more circular cylindrical rechargeable batteries is also possible.

Further, although the previously described first and second embodiments gave examples of the battery cell 11 type as a lithium ion rechargeable battery, the battery cell is no way limited to that type. For example, nickel cadmium rechargeable batteries and nickel hydride rechargeable batteries can also be used. In addition, the first embodiment showed an example of a circuit board holder 23 configured with four projections 23h-23k and the second embodiment gave an example of a cap 41 configured with two projections 41l . . . However, it is possible to form 3 or fewer projections or 5 or more projections. Further, as shown in figures such as FIG. 3(b), a circular conical shape was adopted as the shape of the projections 23h-23k, 41l . . . for the first and second embodiments. However, the shape of the projections is no way limited to that shape. For example, the projections can also have a shape such as a polygonal conical (pyramid) shape, a circular cylindrical shape, or a polygonal cylindrical shape.

As shown in FIG. 7, the circuit board holder 23 projections 23h-23k for the first embodiment were ultimately squashed down. However, depending on the length L₂ of the battery cell 11, a situation where only part of the ends of the projections 23h-23k are squashed, and a situation where the projections 23h-23k are not squashed at all can also be anticipated. The present invention comprehensively includes these situations. Similarly, these same situations occur for projections 41l . . . on the cap 41 of the battery pack 2 as in the second embodiment.

As previously described for the first and second embodiments, even when projections are not provided on the circuit board holder 23 or the cap 41, the battery pack of the present invention can suppress battery cell 11 dimension variation and allow manufacture of a battery pack having highly precise dimensions. Specifically, once the position of the cap unit 20, 40 has been adjusted relative to the battery cell unit 10, welding electrodes can be inserted into the holes 21h-21k, 41j, 41k . . . through the cap 21, 41 to weld-attach the lead-plates together. Therefore, high precision dimensions can be realized for a battery pack even when projections are not provided on the circuit board holder 23 or cap 41.

Finally, since the holes 21h-21k, 41j, 41k . . . in the cap are ultimately covered by the outer label 30, moisture and dirt ingress to the inside of the battery pack can be prevented and a high degree of safety can be achieved.

The present invention is effective for realizing a battery pack having highly precise dimensions.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2009-243478 filed in Japan on Oct. 22, 2009, the content of which is incorporated herein by reference.

What is claimed is:

1. A battery pack comprising:
a battery cell;
a circuit board disposed along one end-plane of the battery cell; and
a circuit board holder that intervenes between the circuit board and the battery cell end-plane,
wherein the circuit board holder is provided with a main body that holds the circuit board, and one or a plurality of projections protruding towards the end-plane of the battery cell; and the projections have lower mechanical strength than the main body, and function as buffers to absorb dimension variation in the battery cell.

2. The battery pack as cited in claim 1 wherein the circuit board holder has a long rectangular shape when viewed perpendicular to the battery cell end-plane, and the projections on the circuit board holder are provided at the four corners of the long rectangular circuit board holder.

3. The battery pack as cited in claim 1 wherein the ends of the projections on the circuit board holder contact the battery cell end-plane or an insulating board disposed on top of the end-plane, and the contacting segments of the projections become squashed.

4. The battery pack as cited in claim 1 wherein the circuit board holder is formed from resin material employing a single-piece construction for the main body and the projections.

5. The battery pack as cited in claim 1 wherein the projections are either very small circular conical shapes, circular cylindrical shapes, polygonal conical shapes, or polygonal cylindrical shapes.

6. The battery pack as cited in claim 1 wherein the circuit board holder has a retaining section to hold the circuit board, and legs protruding from the backside of the retaining section that extend in the negative X-axis direction; and
the projections have a small cross-section through a plane perpendicular to the X-axis compared to the circuit board holder retaining section and legs.

7. The battery pack as cited in claim 1 wherein the projections have a degree of mechanical strength that avoids deformation due to external impact forces occurring during use of the finished battery pack.

8. The battery pack as cited in claim 1 wherein a battery cell unit is configured with attached lead-plates; and the end of each projection on the circuit board holder contacts the battery cell unit.

9. The battery pack as cited in claim 1 wherein the circuit board holder is provided with projections at its four corners.

10. The battery pack as cited in claim 1 wherein a lead-plate is joined to the end-plane of the battery cell, and that lead-plate has a surface that stands up from the end-plane and extends in the direction of the circuit board; the circuit board has a lead-plate with a surface that stands up from the circuit board and extends toward the battery cell end-plane; the circuit board lead-plate connects to the lead-plate on the battery cell end-plane at an overlapping region; the battery cell end-plane, the circuit board, and the circuit board holder are covered by a cap; and holes are provided on both sides of the cap at positions corresponding to the overlapping region of the lead-plate joined to the battery cell end-plane and the circuit board lead-plate, and those holes are opened in directions perpendicular to the primary surfaces of both lead-plates.

11. The battery pack as cited in claim 10 wherein the holes in the cap are sized to allow insertion of the welding electrodes used during weld-attachment of the lead-plates.

12. The battery pack as cited in claim 10 wherein the holes in the cap are covered by sheet material.

13. A battery pack comprising:
a battery cell;
a circuit board disposed along one end-plane of the battery cell; and
a cap that covers the end-plane of the battery cell and the circuit board,
wherein the cap is provided with one or a plurality of projections protruding from the battery cell end-plane side of the cap towards the battery cell end-plane; and the projections on the cap have lower mechanical strength than the rest of the cap and function as buffers to absorb dimension variation in the battery cell.

14. The battery pack as cited in claim 13 wherein the cap has a retaining section to hold the circuit board.

15. The battery pack as cited in claim 13 wherein the cap has projections at both end regions on the Y-axis that protrude in the negative X-axis direction.

16. The battery pack as cited in claim 13 wherein the ends of the projections provided on the cap are squashed down depending on the variation in the length of the battery cell by compression force applied in the X-axis direction.

17. A battery pack comprising:
a battery cell;
a circuit board disposed along one end-plane of the battery cell; and
a cap that covers the end-plane of the battery cell and the circuit board,
wherein a lead-plate is joined to the end-plane of the battery cell, and that lead-plate has a surface that stands up from the end-plane and extends in the direction of the circuit board; the circuit board has a lead-plate with a surface that stands up from the circuit board and extends toward the battery cell end-plane; the circuit board lead-plate connects to the lead-plate on the battery cell end-plane at an overlapping region; and holes are provided on both sides of the cap at positions corresponding to the overlapping region of the lead-plate joined to the battery cell end-plane and the circuit board lead-plate, and those holes are opened in directions perpendicular to the primary surfaces of both lead-plates.

18. The battery pack as cited in claim 17 wherein the holes in the cap are sized to allow insertion of the welding electrodes used during weld-attachment of the lead-plates.
